(19) United States
(12) Patent Application Publication
(10) Pub. No.: US 2026/0126167 A1
(43) Pub. Date: May 7, 2026

(54) A SYSTEM FOR LINKING TOGETHER A PLURALITY OF LUMINAIRES

(71) Applicant: Sylvan R. Shemitz Designs, LLC, West Haven, CT (US)

(72) Inventors: Paul R. Ford, Orange, CT (US); Allison K. Schieffelin, Nantucket, MA (US)

(21) Appl. No.: 19/380,145

(22) Filed: Nov. 5, 2025

Related U.S. Application Data
(60) Provisional application No. 63/716,790, filed on Nov. 6, 2024.

(51) Int. Cl. F21V 21/005; F21S 2/00; F21V 15/015

(52) U.S. Cl. CPC F21V 21/005; F21S 2/005; F21V 15/015

(57) ABSTRACT

A system for connecting a plurality of luminaires including an inner linking element having opposed sides, each side including a central mounting hole and concentric fixing holes, an outer linking element including opposed sides, each side having a central mounting hole and protruding elements arranged concentrically thereabout, where each side of the inner linking element is disposed against and secured to two adjacent luminaires, one end of the outer linking element is disposed atop one end of the inner linking element such that the protruding elements are received within the fixing holes, and the opposing end of the outer linking element is secured to a third luminaire, where relative angular position of the inner and outer links may be varied as desired, and the system may be expanded by introducing additional luminaries and linking elements.

### CROSS REFERENCE TO RELATED APPLICATION

This application is related to and claims the benefit of U.S. Provisional Patent Application Ser. No. 63/716,790, filed on 6 Nov. 2024, the entire contents of which are herein incorporated by reference.

### TECHNICAL FIELD

The disclosure relates to the field of lighting in general and, in particular, to a system for affixing a plurality of lighting fixtures together into a configurable unit.

### BACKGROUND

Often, multiple lighting fixtures or luminaires are needed to properly illuminate a space. For example, brightness can be increased by arranging several luminaires into a single space. Additionally, desired lighting effects, such as uplighting, downlighting, wall washing, etc., can be created by disposing several luminaires together. However, existing technologies do not allow for multiple luminaires to easily be arranged and oriented in tandem, thus complicating installations.

What is needed is system for system for linking together multiple luminaires that allows for ease of installation and customization of the number, type, and position of the luminaires.

### BRIEF SUMMARY

A system is disclosed for linking a plurality of luminaires, including an inner linking element, an outer linking element, a cap, a spacer, and a fixation element.

The inner linking element includes a first circular portion, a second circular portion arranged opposite from the first circular portion, an elongated portion extending between and connecting the first circular portion and the second circular portion, a mounting hole formed through a center of each of the first circular portion and the second circular portion; and a plurality of fixing holes formed through each of the first circular portion and the second circular portion and arranged concentrically around the respective central hole.

The outer linking element includes a first circular portion, a second circular portion arranged opposite from the first circular portion, an elongated portion extending between and connecting the first circular portion and the second circular portion, a mounting hole formed through a center of each of the first circular portion and the second circular portion, and a plurality of protruding elements disposed on an inside surface of each of the first circular portion and the second circular portion and arranged concentrically around the respective central hole.

The plurality of fixing holes of the inner linking element are arranged correspondingly with the plurality of protruding elements of the outer linking element such that the protruding elements are received within the fixing holes when one of the circular portions of the outer linking element is positioned atop one of the circular portions of the inner linking element.

The mounting holes of the inner and outer linking elements are arranged correspondingly such that the mounting hole of the outer linking element is aligned with the mounting hole of the inner linking element when said one of the circular portion of the outer linking element is positioned atop said one of the circular portions of the inner linking element.

The fixation element extends through the aligned mounting holes and is configured to be received and retained by a luminaire to affix the inner and outer linking elements thereto.

The relative angular position of mated inner and outer linking elements can be established as desired by rotating the protruding elements of the outer linking element about the fixing holes of the inner linking element until the desired position is reached and then mating the linking elements such that the protruding elements enter the respective fixing holes.

The system enables a simple and elegant connection of a plurality of luminaires, where the number and relative positioning of each may be customized and varied as desired.

### BRIEF DESCRIPTION OF THE DRAWINGS

For a more complete understanding of this disclosure, reference is now made to the following brief description, taken in connection with the accompanying drawings and detailed description, wherein like reference numerals represent like parts, in which:

FIG. 1 shows an inner linking element;

FIG. 2 shows a cap;

FIG. 3 shows an outer linking element;

FIG. 4 SHOWS A SPACER;

FIG. 5 shows an exploded view of a plurality of luminaires connected by the disclosed system;

FIGS. 6A-6B and 7 show a plurality of luminaires connected linearly;

FIGS. 8 and 9A-9B show a plurality of luminaires connected in V-shaped configurations;

FIGS. 10A-B and 11A-B show a plurality of luminaires connected in zig-zag configurations;

FIGS. 12A-C show a plurality of luminaires connected in a curved configuration;

FIGS. 13A-B show two luminaires connected together;

FIG. 14 shows three luminaires connected together;

FIG. 15 shows an exploded view of two connected luminaires; and

FIG. 16 shows a plurality of connected luminaires and cross-sections thereof.

### DETAILED DESCRIPTION

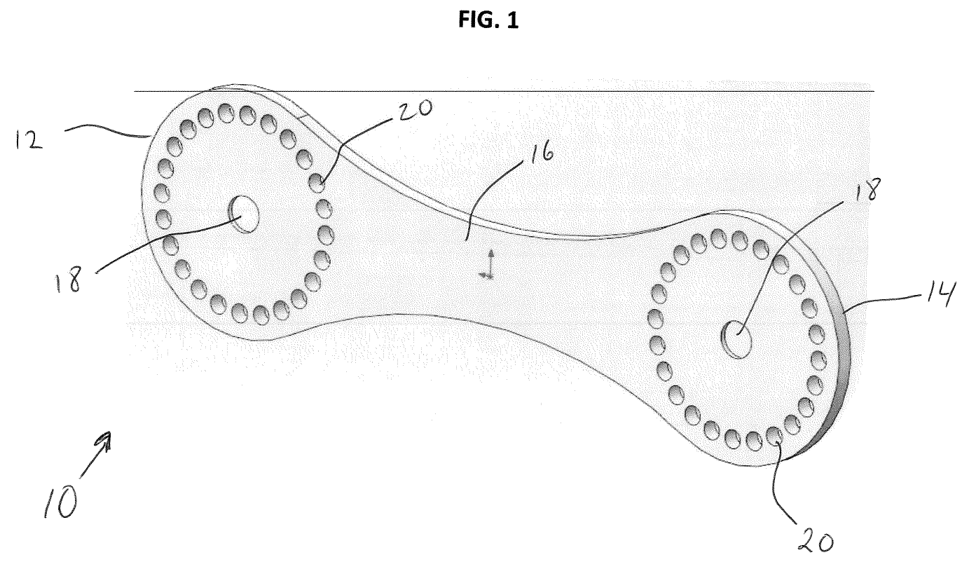

FIG. 1 shows an inner linking element 10 having a first circular portion 12, a second circular portion 14, and an elongated portion 16 extending therebetween. A mounting hole 18 is formed through a center of each of the circular portions 14, 16. A plurality of fixing holes 20 are formed through the inner linking element 10 at each of the first and second circular portions 12, 14 and are arranged concentrically about the respective mounting hole 18. In the illustrated embodiment, the fixing holes 20 are formed near an outer circumference of each of the first and second circular portions 12, 14. Each circular portion 12, 14 includes about 24 of the fixing holes 20, where each fixing hole 20 is spaced at about fifteen degrees from its adjacent fixing holes 20.

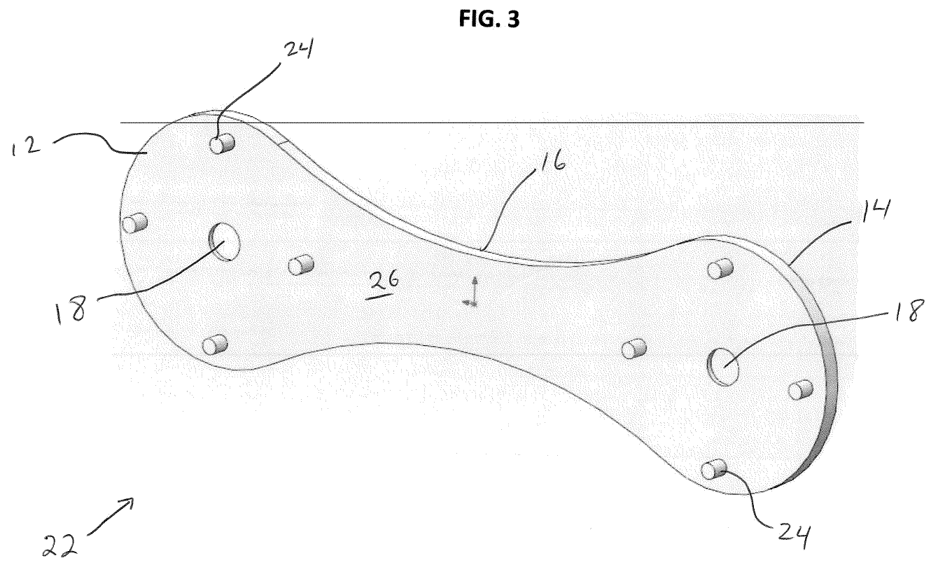

FIG. 3 shows an outer linking element 22 having the previously described first circular portion 12, second circular portion 14, elongated portion 16, and mounting holes 18. The outer linking element 22 is distinguished from the inner linking element 10 in that the former omits the fixing holes 20 and instead includes a plurality of protruding elements 24 disposed on an inside surface 26 of the outer linking element 22. Particularly, a plurality of protruding elements 24 are arranged on each of the first and second circular portions 12, 14, and are arranged concentrically about the respective mounting holes 18. In the illustrated example, about four protruding elements are disposed on each of the first and second circular portions 12, 14 and are arranged at about ninety degrees from one another about the respective mounting holes 18. The protruding elements 24 are arranged near the circumference of the first and second circular portions 12, 14 so as to correspond to the location of the fixing holes 20 of the inner linking element 10.

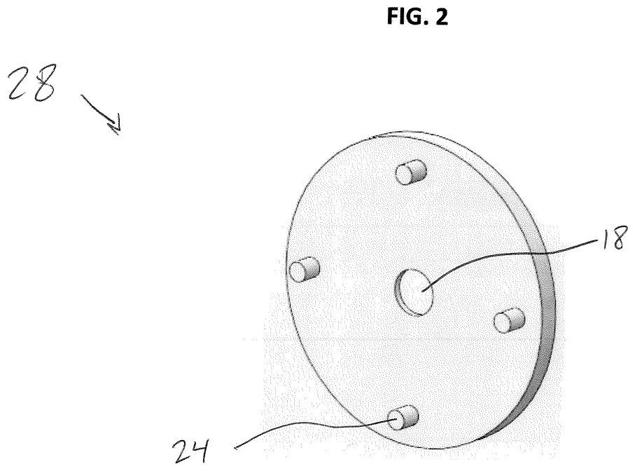

FIG. 2 shows a cap 28 having a circular shape that generally corresponds to the shape and size of the first and second circular portions 12, 14 of the inner linking element 10. The cap 28 includes the previously described protruding elements 24 arranged concentrically about the mounting hole 18 and near an outer circumference of the cap 28. The cap 28 may include the same or a different number of the protruding elements 24 as the first and second circular portions 12, 14 of the outer linking element 22. The protruding elements 24 of the cap 28 may be spaced at ninety degrees, or may be spaced at a greater or lesser angle.

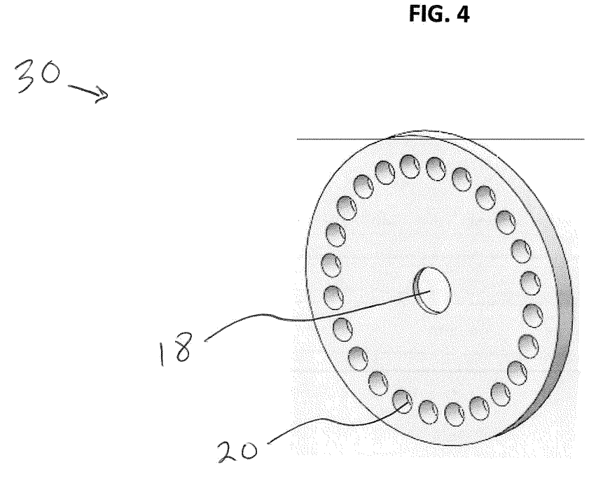

FIG. 4 shows a spacer 30 having a circular shape that generally corresponds to the shape and size of the first and second circular portions 12, 14 of the outer linking element 22. The spacer 30 includes the previously described fixing holes 20 arranged concentrically around the mounting hole 18 near an outer circumference of the spacer 30. The spacer 30 may include the same or a different number of the fixing holes 20 as the first and second circular portions 12, 14 of the inner linking element 10. The fixing holes 20 of the spacer 30 may be spaced at fifteen degrees, or may be spaced at a greater or lesser angle.

The cap 28 is configured to be disposed upon and mate with the inner linking element 10. The inner linking element 10 is a planar member having opposing sides. The cap 28 may be disposed at either the first or second circular portions 12, 14, and on either side of the inner linking element 10. In this position, the protruding elements 24 are received within the respective fixing holes 20 and the mounting hole 18 of the cap 28 is aligned with the corresponding mounting hole 18 of the inner linking element 10.

The spacer 30 is configured to be disposed upon and mate with the outer linking element 22. The outer linking element 22 is a planar member having opposing sides, including the inside surface 26. The spacer 30 may be disposed at either the first or second circular portions 12, 14 on the inside surface of 26 the outer linking element 22. In this position, the protruding elements 24 of the outer linking element 22 are received within the respective fixing holes 20 of the spacer 30. Also, the mounting hole 18 of the cap 30 is positioned in alignment with the corresponding mounting hole 18 of the outer linking element 22.

In a similar manner, the outer linking element 22 is configured to be disposed upon and mate with the inner linking element 10. That is, the first and/or second circular portions 12, 14 of the outer linking element 22 may be disposed at the first and/or second circular portions 12, 14 of the inner linking element 10, and on either side of the inner linking element 10. In this position, the protruding elements 24 of the outer linking element 22 are received within the respective fixing holes 20 of the inner linking element 10 and the respective mounting holes 18 are aligned.

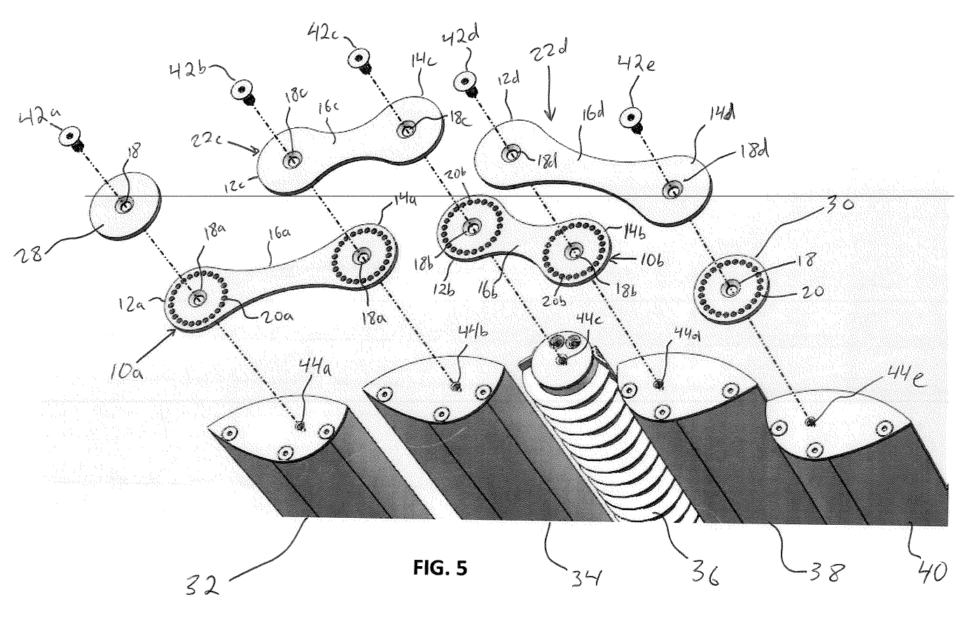

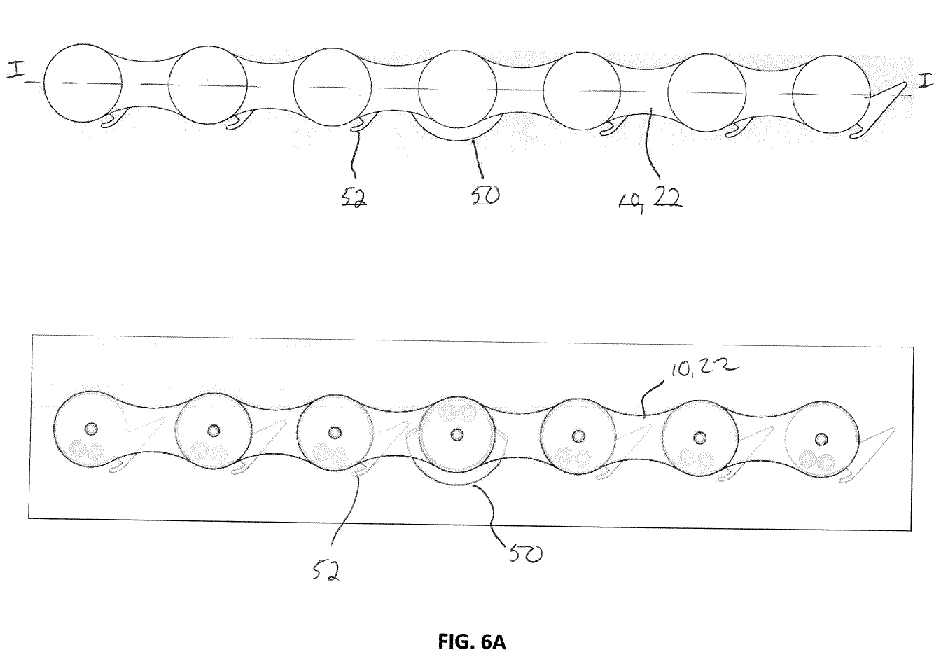

FIG. 5 shows an exploded view of these various mating arrangements relative to a plurality of luminaires 32, 34, 36, 38, 40. The drawing shows a first inner linking element 10a, a second inner linking element 10b, a first outer linking element 22a, a second outer linking element 22b, a cap 28, and a spacer 30. The circular portions 12a, 14a of the first inner linking element 10a are disposed upon an outer end surface of the luminaires 32, 34, respectively. The cap 28 is mated with the circular portion 12a such that the protruding elements 24 are received within the fixing holes 20a. A fixation element 42a, such as a bolt or screw, is passed through the mounting holes 18, 18a of the cap 28 and the circular portion 12a and received within a receptacle 44a of the luminaire 32 and secured therein such that the circular portion 12a of the inner linking element 10a is affixed to the luminaire 32. In similar fashion, the second circular area 14a of the inner linking element 10a is disposed on the luminaire 34 at the receptacle 44b and the first circular area 12c of the outer linking element 22c is disposed atop the second circular area 14a such that the protruding elements 24 of the outer linking element 22c are received within the fixing holes 20a of inner linking element 10a. The fixation member 42b is passed through the mounting holes 18c, 18a and secured at the receptacle 44b such that the second circular portion 14a of the inner linking element 10a and the first circular portion 12c of the outer linking element 22c are secured to the luminaire 34. In this way, the luminaires 32, 34 are connected via the inner linking element 10a.

In a similar manner, the second inner linking element 10b is affixed to the luminaires 36 and 38. That is, the first circular portion 12b of the linking element 10b is disposed at an outer end surface of the luminaire 36 at the receptacle 44c and the second circular portion 14c of the outer linking element 22c is disposed atop the circular portion 12b such that the protruding elements of the former are received within the fixing holes 20b of the latter. The fixation element 42c is passed through the mounting holes 18c and 18b and secured to the luminaire 36 at the receptacle 44c. As such, the inner linking element 10b is affixed to the luminaire 36. Also, the luminaire 36 is now adjoined to the luminaires 32, 34 because the outer linking element 22c fixedly extends between the connected assembly of luminaires 32, 34 to the luminaire 36. Accordingly, the luminaires 32, 34, 36 are connected.

The remaining luminaires 38, 40 are connected to the assembly of luminaires 32, 34, 36 by way of the outer linking element 22d and the second circular portion 14b of the inner linking element 10b. Particularly, the second circular area 14b of the inner linking element 10b is disposed on the luminaire 38 at the receptacle 44d and the first circular area 12d of the outer linking element 22d is disposed atop the second circular area 14b such that the protruding elements of the outer linking element 22d are received within the fixing holes 20b of inner linking element 10b. The fixation member 42d is passed through the mounting holes 18d, 18b and secured at the receptacle 44d such that the second circular portion 14b of the inner linking element 10b and the first circular portion 12d of the outer linking element 22d are secured to the luminaire 38. The second circular area 14d of the outer linking element 22d is affixed to the luminaire 40 by first disposing the spacer 30 at the receptacle 44e, then mating the protruding elements of the outer linking element 22d with the fixing holes 20 of the spacer 30, and passing the fixation element 42e through the mounting holes 18d, 18 and securing the fixation element 42e at the receptacle 44e.

In this manner, the luminaires 32, 34, 36, 38, and 40 have ends which are connected by the linking elements 10a, 10b, 22a, 22b. Opposite ends of the luminaires 32, 34, 36, 38, and 40 may be similarly connected by additional linking elements. Further luminaires may be added to the assembly by simply adding additional linking elements.

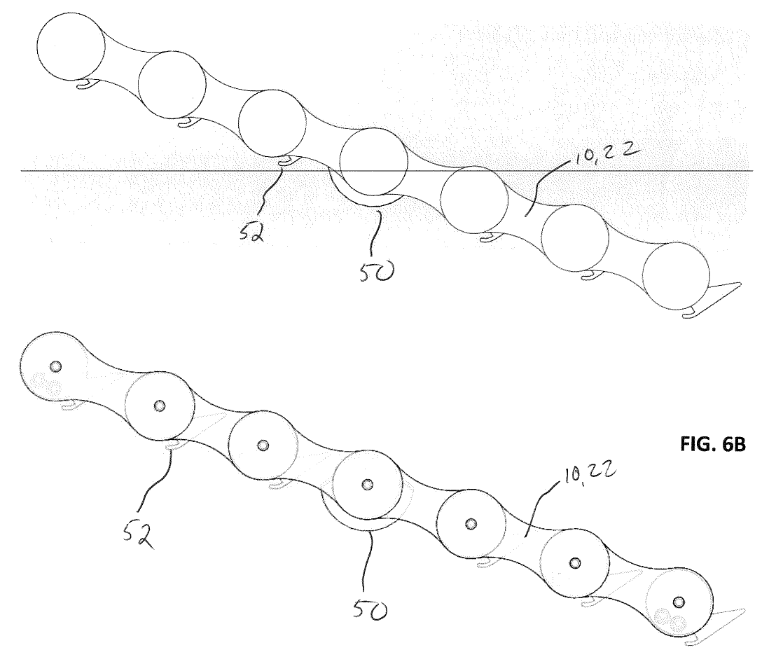

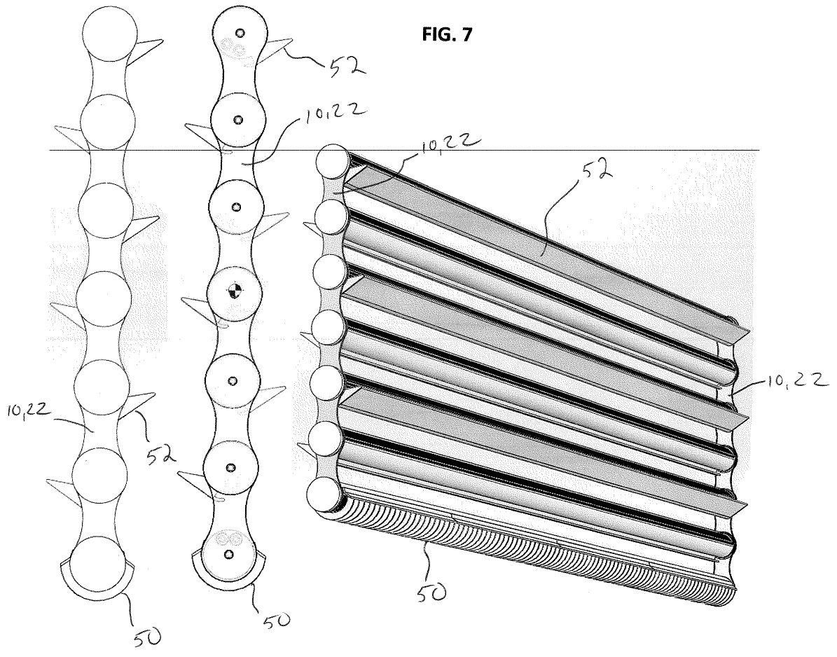

The mating of the protruding elements of the outer linking elements and the fixing holes of the inner linking elements allow for a variety of angular dispositions of the connected luminaires. For example, a plurality of luminaires 50, 52 may be arranged linearly as shown in FIGS. 6A-6B and 7. Here, the linking elements 10, 22 are aligned along a common axis I-I to form a linearly connected assembly of the luminaires 50, 52. In the example of FIG. 6A-6B, a downlight luminaire 50 is centrally disposed in the connected assembly, flanked by uplight luminaires 52. This connected assembly may be disposed in a horizontal position, that is, parallel to floor and/or ceiling as in FIG. 6A or at an angle thereto as in FIG. 6B. In FIG. 7, another linear arrangement of linked luminaires 50, 52 is shown where the downlight luminaire 50 is arranged at an end of the assembly with the uplight luminaires 52 arranged successively therefrom. This assembly may be installed in a vertical position, i.e., perpendicular to floor and/or ceiling.

By rotating mated inner and outer linking elements, angular configurations of the connected luminaires can be created. That is, angles can be formed between adjacent linking elements, and thus between corresponding adjacent luminaires, by rotating the an outer linking element relative to an inner linking element before securing the elements to the respective luminaire with the fixation element. The plurality of fixing holes allow for this rotation and fixing to occur in fifteen degree increments.

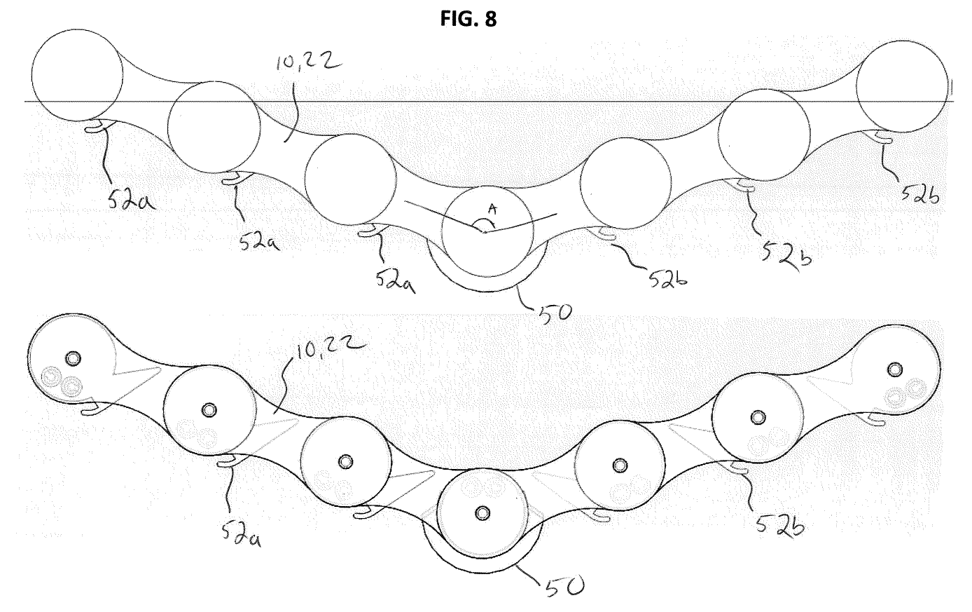

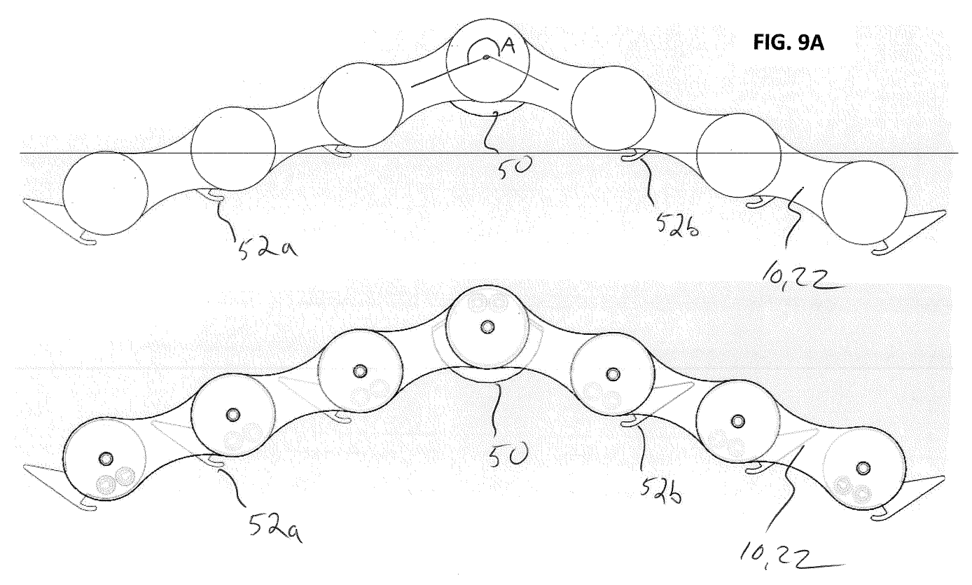

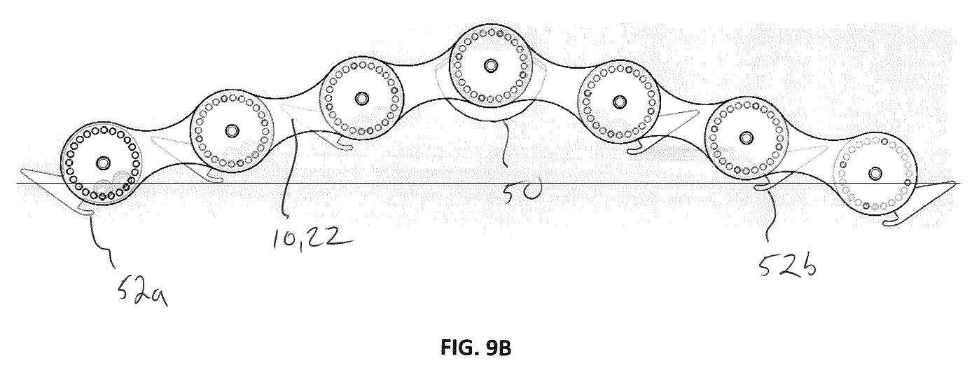

For example, FIG. 8 shows a V-shaped arrangement where inner and outer linking elements 10, 22 are used to connect first uplight luminaires 52a in a linear arrangement. Second uplight luminaires 52b are similarly connected in a linear manner by inner and outer linking elements. The linear array of uplights 52a is affixed at an angle to a centrally disposed downlight luminaire 50. Similarly, the linear array of uplight luminaires 52b is arranged angularly relative to the central downlight luminaire 50. This angular position is achieved simply by rotating a respective outer linking element relative to an adjacent inner linking element prior to mating and then inserting the protruding elements of the outer linking element into the desired fixing holes of the inner linking element so as to fix the outer linking element at a desired angle relative to the inner linking element. For example, in FIG. 8, the array of uplight luminaires 52a is positioned at an angle A of about 120 degrees relative to the linear array of uplight luminaires 52b. FIGS. 9A-9B show an inverse arrangement where the angle A is about 240 degrees thus giving the luminaire assembly an inverted V-shape. The connected luminaires of FIGS. 8-9 are intended to by installed horizontally, i.e., parallel to ground and/or ceiling.

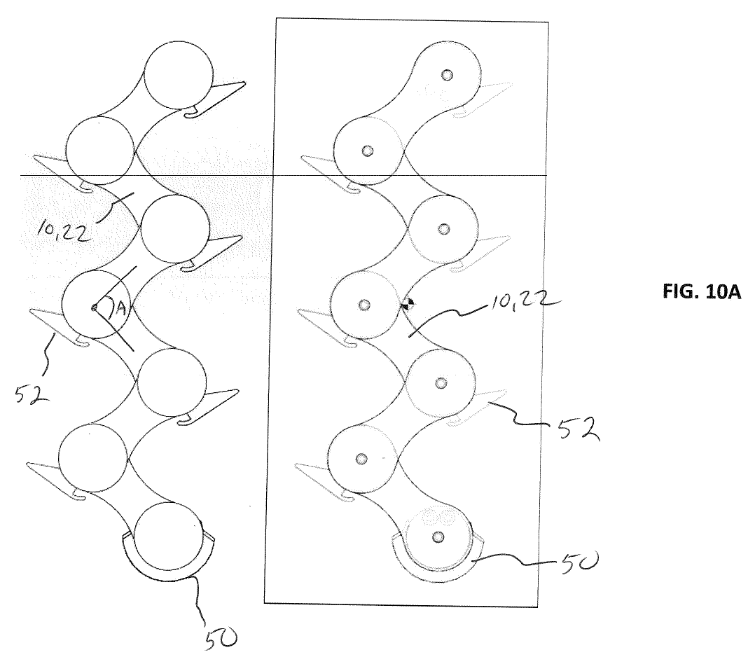

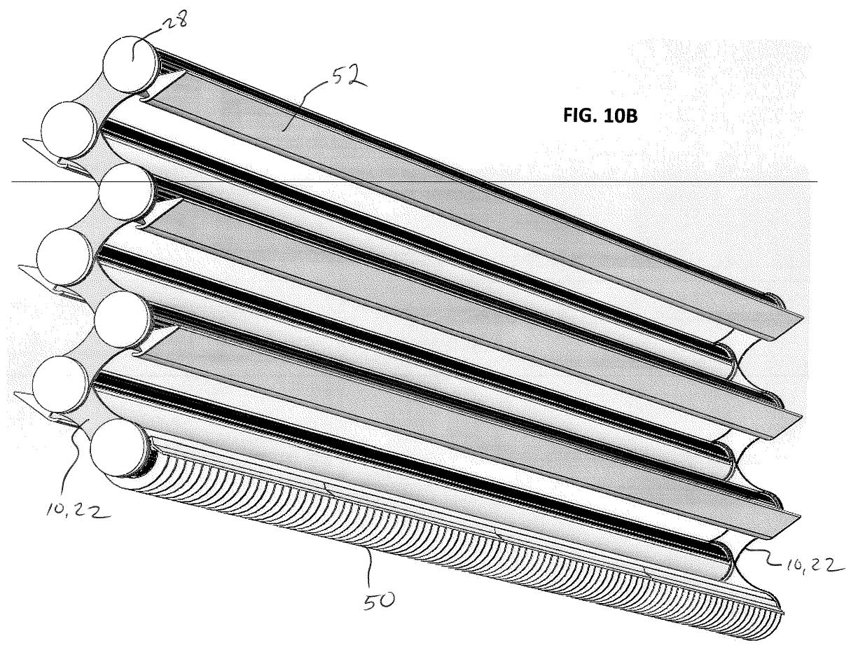

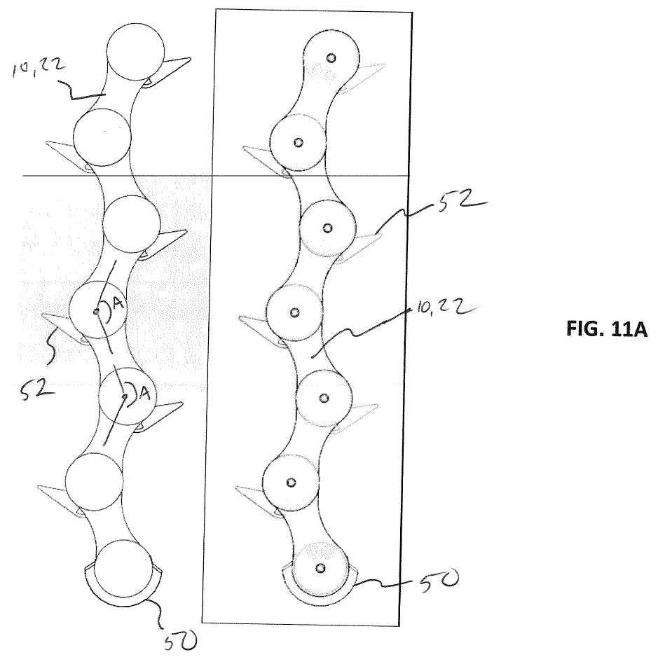

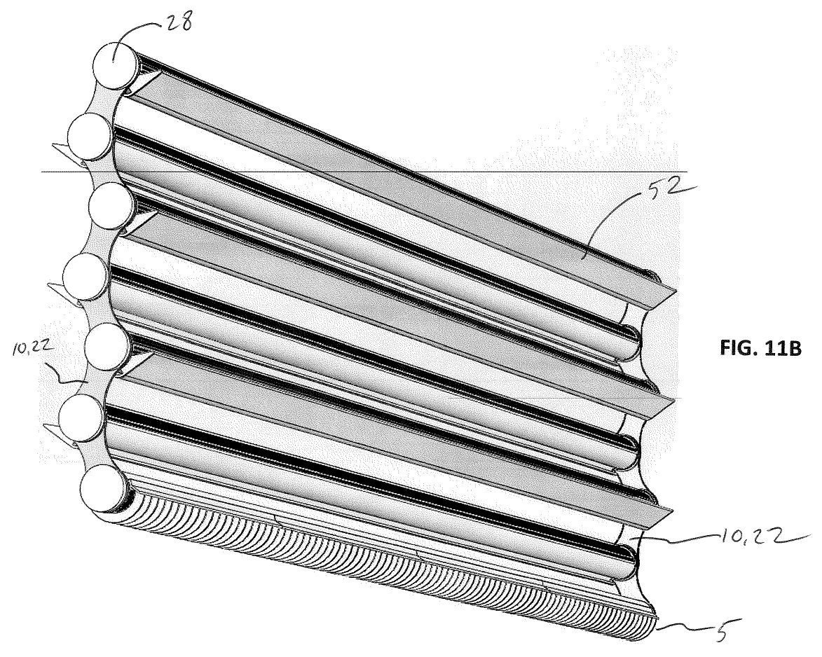

FIGS. 10A-B show an alternate arrangement of connected luminaires 50, 52 where the angle A between adjacent linking elements 10, 22 alternates between about 90 degrees and about 270 degrees to thus give the assembly a zig-zag appearance. Here, the down light luminaire 50 is disposed at an end of the connected assembly with the uplight luminaires 52 connected successively thereto. Such configuration may be installed vertically, i.e., perpendicularly relative to ground and/or ceiling.

FIGS. 11A-11B show a connected assembly of luminaires 50, 52 similar to that of FIGS. 10A-10B except that here the angle A between adjacent linking elements 10, 22 alternates between about 120 degrees and about 240 degrees, giving the assembly a more elongated zig-zag appears as compared to the configuration of FIGS. 10A-10B. Like the previous embodiment, the down light luminaire 50 of FIGS. 11A-B is disposed at an end of the connected assembly with the uplight luminaires 52 connected successively thereto. Such configuration may be installed vertically, i.e., perpendicularly relative to ground and/or ceiling.

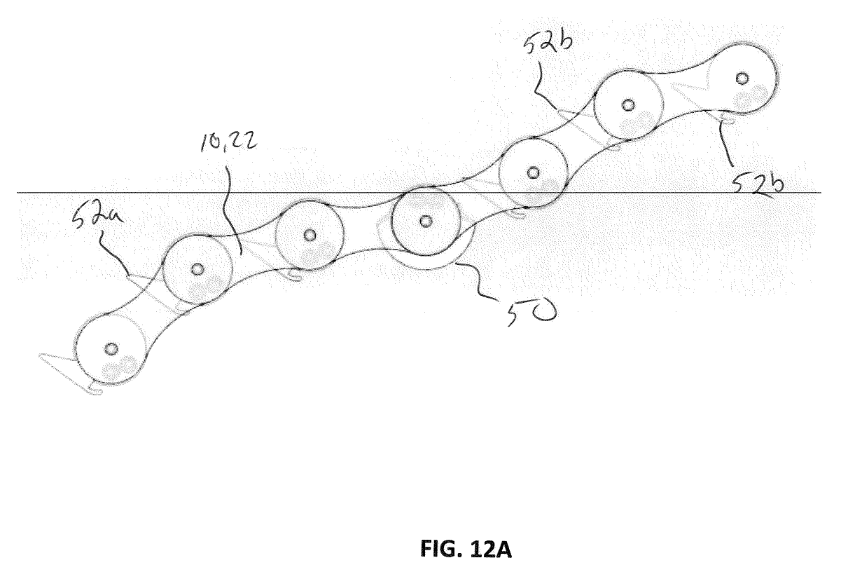

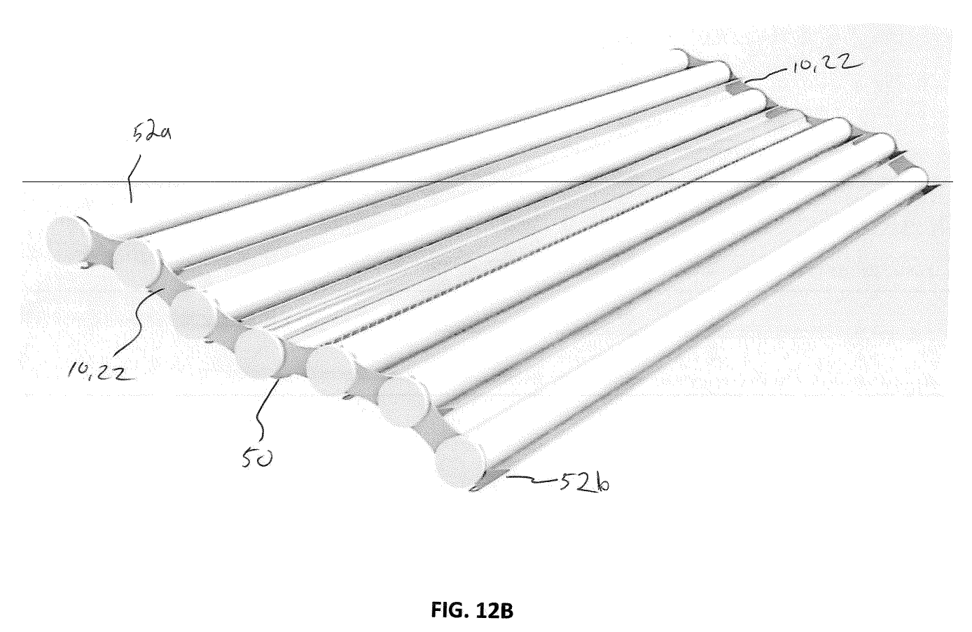

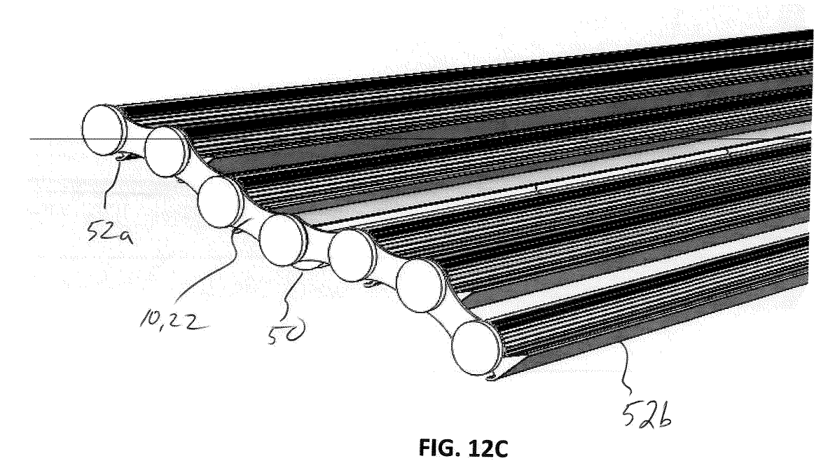

FIGS. 12A-12C show another assembly of connected downlight and uplight luminaires 50, 52 where the downlight 50 is arranged centrally. A first grouping of downlight luminaires 52a is arranged on one side of the central down light luminaire 50 with inner and outer linking elements mated so as to provide a downwardly curving configuration. A second grouping of downlight luminaires 52b is arranged on an opposite side of the central down light luminaire 50 with inner and outer linking elements mated so as to provide an upwardly curving configuration.

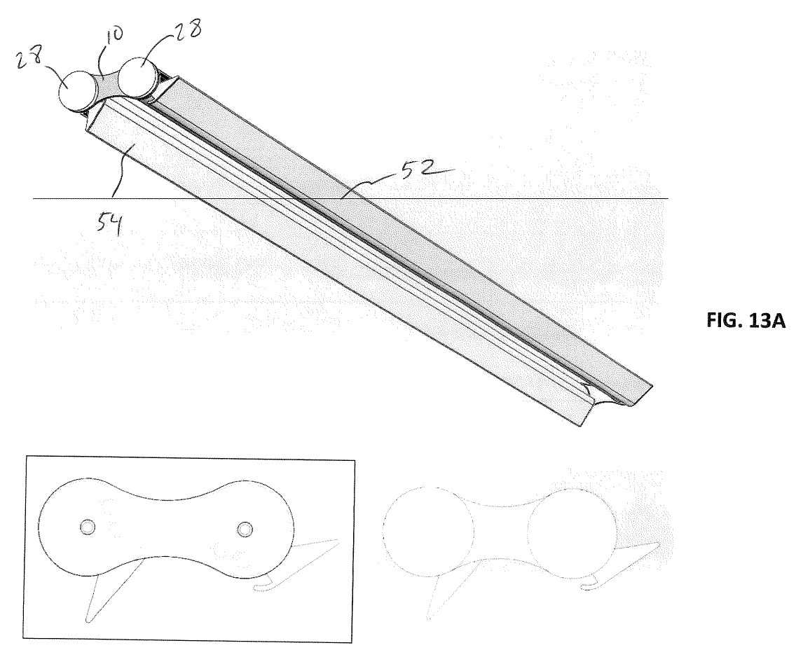

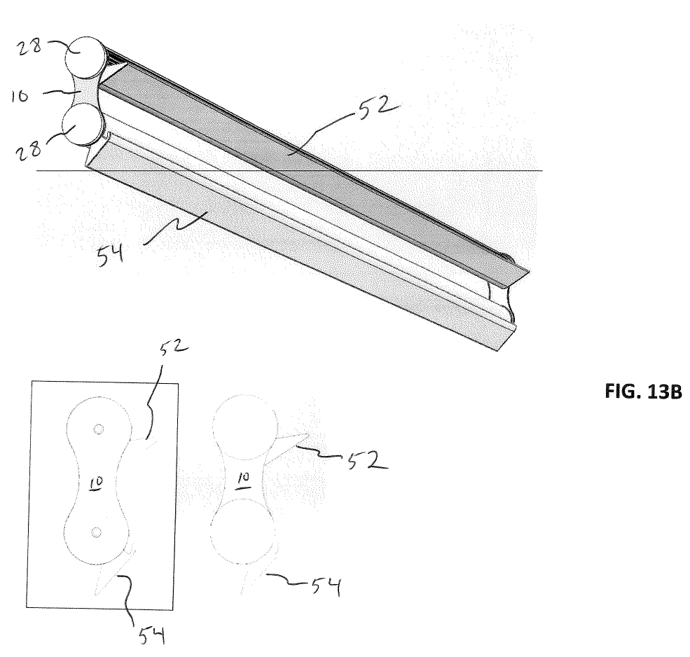

Any number of luminaires can be connected together using the linking elements disclosed herein. For example, as few as two luminaires can be adjoined as shown in FIGS. 13A-13B. Such luminaires can be arranged to be disposed in a horizontal or vertical position, or even angled. The luminaires may comprise any type of elongated lighting fixture. FIGS. 13A-13B show exemplary uplight luminaires 52 and wall wash luminaires 54. These may be exchanged as desired with downlight luminaires 50 or with any other desired luminaire.

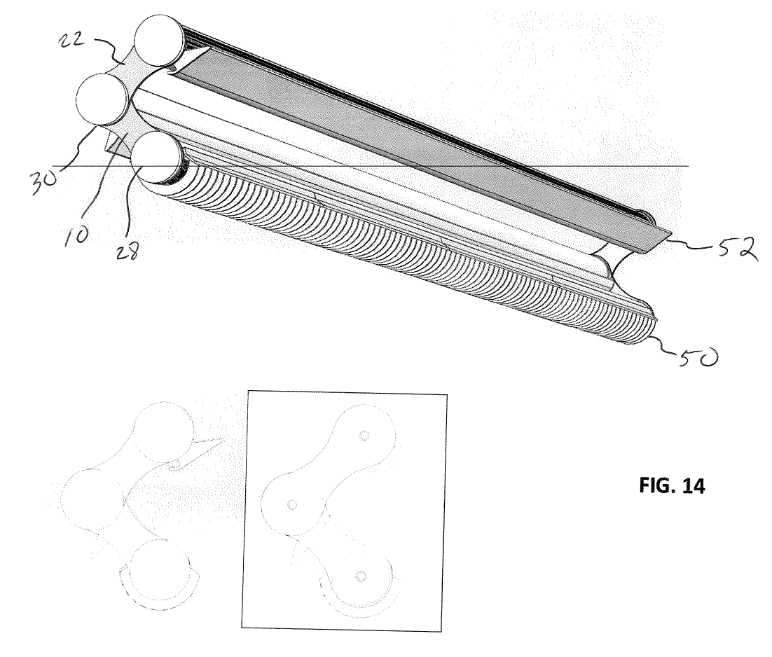

FIG. 14 shows an alternate arrangement in which linking elements 10, 22 connect three luminaires: a downlight luminaire 50, an uplight luminaire 52, and a wall wash luminaire 54. Any number of additional luminaires can be added to the assembly simply by adding more linking elements.

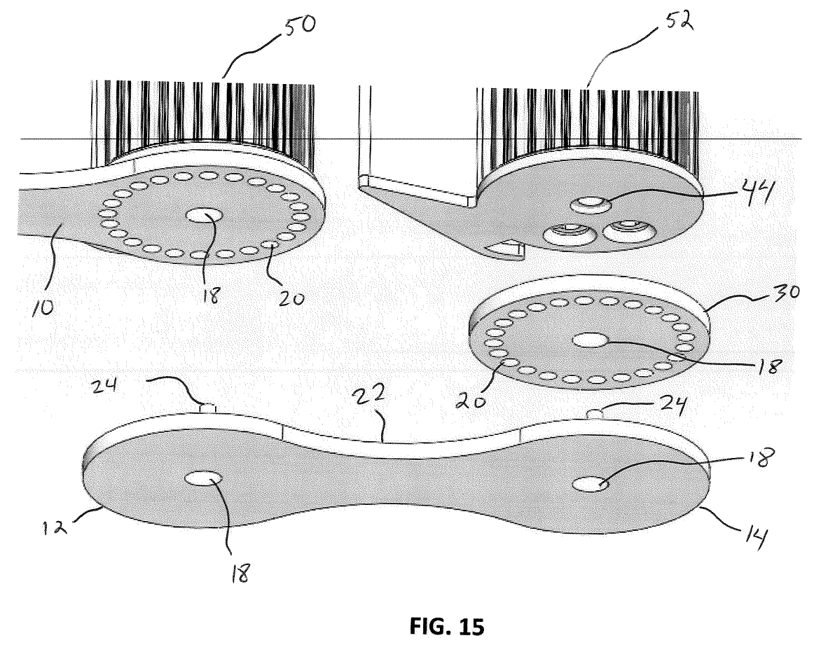

FIG. 15 shows an exploded view of a downlight luminaire 50 connected to an uplight luminaire 52. A spacer 30 is disposed upon the outer end surface of the uplight luminaire 52 and its mounting hole 18 is aligned with the receptacle 44. An inner linking element 10 is placed upon the downlight luminaire 50 and its mounting hole 18 is aligned with the receptacle 44 of the luminaire 50. An outer link 22 is used to connect the luminaires 50, 52. Particularly, the first circular portion 12 of the outer linking element 22 is arranged atop the inner linking element 10 such that the protruding element 24 is received within one of the fixing holes 20. A fixation element (not shown) is then inserted through the mounting holes 18 and into the receptacle of the luminaire 50 in order to secure the inner and outer linking elements 10, 22 thereto. The second circular portion 14 of the outer linking element 22 is arranged atop the spacer 30 such that the protruding element 24 is received within one of the fixing holes 20 of the spacer 30. A fixation element (not shown) is then inserted through the mounting holes 18 and into the receptacle of the luminaire 52 in order to secure the outer linking element 22 and the spacer 30 thereto. In this way, the luminaires 50, 52 are connected together and may be installed in tandem. Additional luminaires may be connected to the luminaires 50, 52 in like manner, as desired, and the positioning of adjacent luminaires may be prescribed by rotating the protruding elements 24 relative to the fixing holes 20 and inserting where desired.

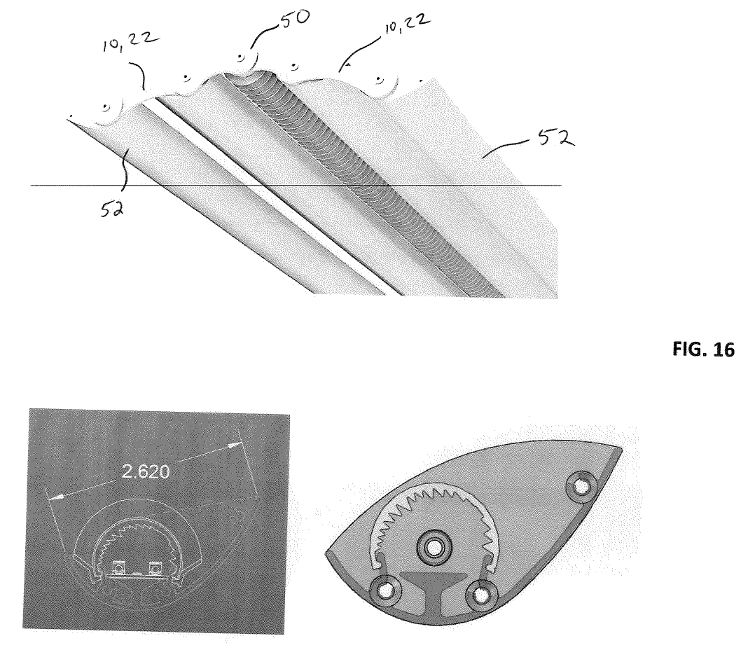

FIG. 16 shows a linked arrangement of four uplight luminaires 52 with a centrally disposed downlight luminaire 50. FIG. 16 also shows cross-sectional views of exemplary luminaires. Various alternate housings may be used for the luminaires 50, 52. The downlight luminaire 50 may for example utilize shielding of the adjacent uplight luminaires 52.

As shown, for example, in FIG. 7, the linking elements 10, 22 are applied to either end of a plurality of elongating luminaires 50, 52 in order to create a connect bank of lighting fixtures which may be installed as a singular unit. The plurality of luminaires 50, 52 may be wired together and powered from a common sources, or may have individual wirings which extend to one or more power sources.

The configurations and descriptions provided herein are exemplary. The broad scope of the invention contemplates variations and alternative.

The inner and outer linking elements 10, 22 are described by way of example as included two circular portions with a elongated portion therebetween, thus giving the elements 10, 20 a chain-link or dog-bone appearance. Other shapes may be used for the linking elements 10, 22, for example, they may be rectilinear, rod like, curvilinear, etc. The number, size, shape, and disposition of the mounting holes 18, fixing holes 20, and protruding elements 24 may vary. These may be for example circular in shape, or rectilinear or curvilinear. There may be four protruding elements 24, or more than four, or less than four. There may be twenty fixing holes 20, or more than twenty or less than twenty.

Various embodiments of the present invention are described herein with reference to the related drawings. Alternative embodiments can be devised without departing from the scope of this invention. It is noted that various connections and positional relationships (e.g., over, below, adjacent, etc.) are set forth between elements in the following description and in the drawings. These connections and/or positional relationships, unless specified otherwise, can be direct or indirect, and the present invention is not intended to be limiting in this respect. Accordingly, a coupling of entities can refer to either a direct or an indirect coupling, and a positional relationship between entities can be a direct or indirect positional relationship.

The term “exemplary” is used herein to mean “serving as an example, instance, or illustration.” Any embodiment or design described herein as “exemplary” is not necessarily to be construed as preferred or advantageous over other embodiments or designs. The terms “at least one” and “one or more” are understood to include any integer number greater than or equal to one, i.e. one, two, three, four, etc. The terms “a plurality” are understood to include any integer number greater than or equal to two, i.e. two, three, four, five, etc. Terms such as “connected to”, “affixed to”, etc., can include both an indirect “connection” and a direct “connection.”

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed:

1. An inner linking element for connecting a plurality of luminaires, comprising:
a first circular portion;
a second circular portion arranged opposite from the first circular portion;
an elongated portion extending between and connecting the first circular portion and the second circular portion;
a mounting hole formed through a center of each of the first circular portion and the second circular portion; and
a plurality of fixing holes formed through each of the first circular portion and the second circular portion and arranged concentrically around the respective central hole.

2. The inner linking element of claim 1, further comprising a cap shaped complimentary to the first circular portion and the second circular portion and having a mounting hole formed centrally therethrough with a plurality of protruding elements arranged concentrically around the mounting hole.

3. The inner linking element of claim 2, wherein the cap is configured to be disposed upon at least one of the first and second circular portions, where the protruding elements are received in the fixing holes, and the mounting holes are aligned to allow a fixation member to pass therethrough to fix the inner linking element upon a luminaire.

4. An outer linking element for connecting a plurality of luminaires, comprising:
a first circular portion,
a second circular portion arranged opposite from the first circular portion,
an elongated portion extending between and connecting the first circular portion and the second circular portion,
a mounting hole formed through a center of each of the first circular portion and the second circular portion, and
a plurality of protruding elements disposed on an inside surface of each of the first circular portion and the second circular portion and arranged concentrically around the respective central hole.

5. The outer inking element of claim 4, further comprising a spacer shaped complimentary to the first circular portion and the second circular portion, the spacer having a mounting hole formed centrally therethrough and a plurality of fixing holes formed therethrough and arranged concentrically around the central hole.

6. The outer linking element of claim 5, wherein the spacer is configured to be disposed between the inside surface of one of the first and second circular portions and a luminaire such that the pins are received in the fixing holes and such that the mounting holes are aligned to allow a fixation member to pass therethrough to fix the linking element upon a luminaire.

7. A system for linking a plurality of luminaires, comprising:
an inner linking element comprising the linking element of claim 1;
an outer linking element comprising the linking element of claim 4; and
a fixation element;
wherein the plurality of fixing holes of the inner linking element are arranged correspondingly with the plurality of protruding elements of the outer linking element such that the protruding elements are received within the fixing holes when one of the circular portions of the outer linking element is positioned atop one of the circular portions of the inner linking element; and
wherein the mounting holes of the inner and outer linking elements are arranged correspondingly such that the mounting hole of the outer linking element is aligned with the mounting hole of the inner linking element when said one of the circular portion of the outer linking element is positioned atop said one of the circular portions of the inner linking element;
wherein the fixation element extends through the aligned mounting holes and is configured to be received and retained by a luminaire to affix the inner and outer linking elements thereto.

8. The system of claim 7, further comprising a cap shaped complimentary to the first circular portion and the second circular portion of the inner linking element and having a mounting hole formed centrally therethrough with a plurality of protruding elements arranged concentrically around the mounting hole.

9. The system of claim 8, wherein the cap is configured to be disposed upon at least one of the first and second circular portions of the inner linking element, where the protruding elements are received in the fixing holes, and the mounting holes are aligned to allow the fixation member to pass therethrough to fix the inner linking element upon the luminaire.

10. The system of claim 7, further comprising a spacer shaped complimentary to the first circular portion and the second circular portion of the outer linking element, the spacer having a mounting hole formed centrally therethrough and a plurality of fixing holes formed therethrough and arranged concentrically around the central hole.

11. The system of claim 10, wherein the spacer is configured to be disposed between the inside surface of one of the first and second circular portions of the outer linking element and the luminaire such that the pins are received in the fixing holes and such that the mounting holes are aligned to allow the fixation member to pass therethrough to fix the linking element upon the luminaire.

12. A lighting fixture assembly, comprising:
a first luminaire having a first end and an opposing second end;
a second luminaire having a first end and an opposing second end;
a third luminaire having a first end and an opposing second end;
wherein the inner linking element of claim 1 is connected to the first ends of the first and second luminaires; and
wherein the outer linking element of claim 4 is disposed atop the inner linking element at the first end of the second luminaire and is affixed thereto; and
wherein the outer linking element is connected to the first end of the third luminaire.

13. The light fixture assembly of claim 12, further comprising a fourth luminaire having a first end and an opposing second end wherein a second outer linking element is disposed atop the inner linking element at the first end of the first luminaire and is affixed thereto, and wherein the second outer linking element is connected to the first end of the fourth luminaire.
